(19) United States
(12) Patent Application Publication
(10) Pub. No.: US 2024/0392178 A1
(43) Pub. Date: Nov. 28, 2024

(54) NONFLAMMABLE REFRIGERANTS HAVING LOW GWP, AND SYSTEMS FOR AND METHODS OF PROVIDING REFRIGERATION

(71) Applicant: HONEYWELL INTERNATIONAL INC., Charlotte, NC (US)

(72) Inventors: Nilesh Purohit, Charlotte, NC (US); Kaimi Gao, Charlotte, NC (US); Ankit Sethi, Charlotte, NC (US); Ryan Hulse, Charlotte, NC (US)

(73) Assignee: HONEYWELL INTERNATIONAL INC., Charlotte, NC (US)

(21) Appl. No.: 18/615,590

(22) Filed: Mar. 25, 2024

Related U.S. Application Data
(63) Continuation-in-part of application No. 18/198,606, filed on May 17, 2023.
(60) Provisional application No. 63/454,325, filed on Mar. 24, 2023.

(51) Int. Cl. C09K 5/04; F25B 9/10

(52) U.S. Cl. CPC C09K 5/045; F25B 9/10; C09K 2205/126; C09K 2205/22; F25B 2400/121

(57) ABSTRACT

The present invention provides cascade refrigeration systems in which the low stage consists essentially of R454A and the high stage comprises a refrigerant that is either Class A1 or Class A2L and comprises at least about 75% by weight of HFO-1234ze(E).

### CROSS REFERENCE TO RELATED APPLICATIONS

The present invention is related to and claims the priority benefit of U.S. application Ser. No. 18/198,606, filed May 17, 2023, and U.S. Provisional Application No. 63/454,325 filed Mar. 24, 2023, each of which is incorporated herein in its entirety as if fully set forth below.

### FIELD OF THE INVENTION

The present invention relates to high efficiency, low-global warming potential (“low GWP”) refrigerants and to air conditioning and/or refrigeration systems and methods for providing cooling, including particularly cascaded refrigeration systems, which are safe and effective.

### BACKGROUND

The refrigeration industry is under increasing pressure—through regulatory changes and otherwise—to replace high global warming potential (GWP) refrigerants, such as R134a and R404A, with low GWP refrigerants, such as refrigerants with GWP below 150. This is of particular importance in commercial refrigeration systems, where high volumes of refrigerant are used.

One approach has been to use low GWP refrigerants, such as carbon dioxide (R744) and hydrocarbon refrigerants. However, such an approach as has been heretofore used can suffer from significant safety and financial drawbacks, such as: poor system energy efficiency, leading to increased operating costs; high system complexity, leading to high initial system costs; low system serviceability and reliability, leading to high maintenance costs; and high system flammability. Systems which include highly flammable refrigerants according to prior arrangements have been particularly disadvantageous as they can lead to poor levels of safety; can conflict with regulatory code restrictions; and can increase liability on refrigeration system operators and manufacturers. Safety is a particular concern given that many commercial refrigeration applications, such as supermarket fridges, freezers and cold display cases are publicly accessible and often operate in densely populated spaces.

Applicants have come to appreciate, therefore, that the refrigeration industry continues to need safe, robust, and sustainable approaches for reducing the use of high GWP refrigerants which can be used with existing technologies.

One such approach that has been previously used is shown in FIG. 1A. FIG. 1A shows a refrigeration system 100 which is commonly used for commercial refrigeration in supermarkets. The system 100 is a direct expansion system which provides both medium and low temperature refrigeration via medium temperature refrigeration circuit 110 and low temperature refrigeration circuit 120.

In a typical prior configuration labelled as 100 in FIG. 1A, the medium temperature refrigeration circuit 110 has R134a as its refrigerant. The medium temperature refrigeration circuit 110 provides both the medium temperature cooling and removes the rejected heat from the lower temperature refrigeration circuit 120 via a heat exchanger 130. The medium temperature refrigeration circuit 110 extends between a roof 140, a machine room 141 and a sales floor 142. The low temperature refrigeration circuit 120 on the other hand has R744 as its refrigerant. The low temperature refrigeration circuit 120 extends between the machine room 141 and the sales floor 142. Usefully, as discussed above, R744 has a low GWP.

However, while refrigeration systems of the type disclosed in FIG. 1A may be able to provide good efficiency levels, applicants have come to appreciate that systems of this type have at least two major drawbacks: first, such systems use the high GWP refrigerant R134a (R134a having a GWP of around 1300); and second, even though the low temperature portions of such systems uses the low GWP refrigerant R744, this refrigerant exhibits the many drawbacks discussed above, including significant safety and financial drawbacks.

Furthermore, in certain refrigeration applications, it is necessary to cool articles but without exposing those articles to temperatures below a certain temperature, such as the freezing point of water. For example, it is common in a supermarket environment to keep certain produce at a reduced temperature relative to the ambient, but at the same time it is disadvantageous to cool that produce below the freezing point of water, especially since the preferred method of cooling involves indirect cooling with humid, ambient air. For these applications, it is also disadvantageous to have, along the evaporator, refrigerant temperatures below freezing point of water, as they will cause frost accumulation and consequently the need to defrost the equipment. Avoiding frost accumulation is an important aspect in those applications. Similarly, cooling of beverages, including water and the like, should also be conducted under conditions which avoid exposing such products to temperatures below the freezing point of water since freezing of such products is not desirable at the point of sale. For the purpose of convenience, applicants will refer herein to such applications, methods and systems as “no-freeze” applications, methods and systems.

Certain single-component fluorocarbons, including chlorofluorocarbons (“CFCs”), hydrochlorofluorocarbons (“HCFCs”), and hydrofluorolefins (“HFOs”), have been used in “no frost” applications in which the refrigerant temperature along the evaporator must remain above the freezing point of water so that frost does not accumulate on the coil surface and, consequently, defrost is not required. In such refrigeration applications, systems and methods, the use of single component fluids has heretofore been considered particularly desirable because the saturation temperature of such fluids does not change upon evaporation of the fluid at constant pressure. This is highly desirable because it permits the system or method to be designed with a refrigerant temperature along the evaporator that remains essentially constant during the evaporation processes, and above the freezing temperature of water, assuming little or no pressure drop as the refrigerant flows through the evaporator. In addition, produce applications also typically require a small temperature difference between air and refrigerant to reduce the dehumidification of the air and consequent removal of moisture content and loss of quality of the produce. The requirements of small temperature differences and avoiding frost formation combined with the need for the evaporator to have a certain positive degree of superheat at the exit can be important in selecting a specific refrigerant in such applications. A degree of superheat equal to or below zero, i.e., refrigerant is not superheated, may lead to reduction in cooling capacity, efficiency and potential compressor failure. The term “degree of superheat” or simply “superheat” means the temperature rise of the refrigerant at the exit of the evaporator above the saturated vapor temperature (or dew temperature) of the refrigerant.

This is illustrated, by way of example in FIG. 1B, which represents in schematic form a typical supermarket produce cooling case. Typically, as illustrated in FIG. 1, cooled, moisture-bearing air is provided to the product display zone of the display case by passing air, both from outside of the case 102 and from recirculating air 104, over the heat exchange surface of an evaporator coil 106 disposed within the display case in a region which is typically separate from (or at least hidden from the view of the consumer) but near to the product display zone. The evaporator 106 has a single component refrigerant inlet 108 and a single component refrigerant outlet 110. A circulating fan 114 is also used. It is highly desirable in systems of the type illustrated above that the cooled space 112 in the refrigeration system has a refrigerant temperature along the evaporator that always or substantially always is above a certain level. For example, in many applications such as refrigeration of produce, the minimum discharge (exit) temperature of the air in the display case is set by design to be about 2° C. to 3° C. in order to provide a margin of safety for avoidance of having a cooled space or cooled article that is below the freezing point of water. In addition, in order to minimize the removal of moisture from the air and consequent drying of produce (loss of quality), the temperature difference between air exit and refrigerant needs to be small, typically 2° C. to 3° C. This, combined with the fact that the evaporator of these applications requires a degree of superheat of about 3 to about 5° C., will impose a constraint on the allowable evaporator glide of the refrigerant so that the evaporation temperature remains above the freezing point of water and, as a result, frost does not accumulate.

Those skilled in the art will appreciate that these two desirable results have heretofore been frequently very difficult to provide refrigerants that are multi-component blends of different single component refrigerants.

Prior to the present invention, those skilled in the art have utilized mainly single component refrigerants, such as HFC-134a, in such applications having low temperature sensitivity, as discussed above, and avoided refrigerant blends because blends generally undergo a significant change in boiling point temperature upon evaporation, which has heretofore been perceived as a major obstacle to the ability to identify blends having the correct balance of properties to be useful in such systems.

On the other hand, Applicants have come to appreciate that it is also difficult in many applications to identify a single-component fluid that possesses the full set of properties that make it of particular advantage in applications of the type discussed above. For example, in many important applications, it is necessary to identify a refrigerant that simultaneously: (1) has workable glide, i.e. a glide of less than 4.5° C., preferably below about 4° C., and even more preferably below about 3° C., to avoid frost formation and be able to maintain a typical degree of superheat, e.g. about 3° C. to about 5° C.; (2) is non-flammable (Class A1) or only slightly flammable (Class A2L); (3) has low or no substantial toxicity; (4) has low global warming potential (GWP) (e.g., less than about 150), and (5) has heat transfer and other properties (such as chemical stability) that match the needs of the particular applications, especially in medium temperature heat transfer systems and even more preferably in no-frost or low-frost medium temperature refrigeration systems. While the use of single component refrigerants has been able in many cases to satisfy items (1) (2), and (3), those skilled in the art have found it difficult (if not impossible) to heretofore find a refrigerant (whether single component or otherwise) that can satisfy not only items (1), (2), and (3) but most of and preferably all of items (4)-(5). Here a non-flammable substance would be classified as class “1” by ASHRAE and a low toxicity substance is classified as class “A” by ASHRAE Standard 34-2016. A substance which is non-flammable and low toxicity would be classified as “A1” by ASHRAE Standard 34-2016.

For example, while HFC-134a has heretofore been used for certain no-freeze applications, it nevertheless fails to satisfy, for example, the low GWP requirement (item 5 above), as HFC-134a has a GWP of about 1300.

Applicants proceeded in a manner contrary to the accepted wisdom and discovered unexpected and advantageous results. For example, Applicants have found, as described in detail hereinafter, that certain blends comprising a carefully selected combination of components can have an advantageous but unexpected combination of non-flammability while at the same time having excellent heat transfer properties, low GWP (e.g., a GWP of less than about 150), low- or no-toxicity, chemical stability, and lubricant compatibility, among others. Furthermore, Applicants have found that the refrigerant compositions of the present invention have particular advantage for use in medium temperature refrigeration systems, and particularly in medium temperature refrigeration systems that are in a cascaded refrigeration system and/or in which it is desired to maintain the cooled-air temperature above about 0° C., and to avoid exposing the air being cooled to temperatures below about 0° C., in order to protect the articles being cooled from frost and/or to prevent frosting of the evaporator coils, which itself may have a negative impact on the overall efficiency of such systems due to the need for defrosting and/or inconsistent cooling across the coils.

### SUMMARY OF THE INVENTION

Applicants have discovered refrigerant compositions, heat transfer compositions comprising the refrigerant, refrigeration methods and systems, including cascade heat transfer methods and systems, and/or to methods and systems for cooling materials that have low temperature constraints, such as low- or no-freeze applications described above.

The present invention includes a cascade refrigeration system, comprising:
(a) a low stage refrigeration circuit comprising:
   a low stage refrigerant comprising at least about 60% by weight of HFO-1234yf and having a GWP of about 150 or less; and
   a compressor;
(b) an inter-circuit heat exchanger in which said low stage refrigerant condenses; and
(c) a high stage refrigeration circuit comprising a high stage refrigerant which: (i) has a Class A1 or a Class A2L flammability; and (ii) evaporates at a temperature below said low stage refrigerant condensing temperature; and (iii) comprises at least about 77% by weight of HFO-1234ze (E), wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 1A.

The present invention includes a cascade refrigeration system, comprising:
(a) a low stage refrigeration circuit comprising:
   (i) a low stage refrigerant comprising at least about 60% by weight of HFO-1234yf and having a GWP of about 150 or less and a Class A1 or Class A2L flammability; and
   (ii) a compressor;
(b) an inter-circuit heat exchanger in which said low stage refrigerant condenses; and
(c) a high stage refrigeration circuit comprising a high stage refrigerant which: (i) has a Class A1 flammability or a Class A2L flammability; and (ii) evaporates at a temperature below said low stage refrigerant condensing temperature; and (iii) comprises at least about 77% by weight of HFO-1234ze (E), wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 1B.

The present invention includes a cascade refrigeration system, comprising:
(a) a low stage refrigeration circuit comprising:
   (i) a low stage refrigerant comprising at least about 60% by weight of HFO-1234yf and at least about 30% by weight of R32 and having a GWP of about 150 or less and a Class A2L flammability or a Class A1 flammability; and
   (ii) a compressor;
(b) an inter-circuit heat exchanger in which said low stage refrigerant condenses; and
(c) a high stage refrigeration circuit comprising a high stage refrigerant which: (i) has a Class A1 flammability; and (ii) evaporates at a temperature below said low stage refrigerant condensing temperature; and (iii) comprises at least about 77% by weight of HFO-1234ze (E), wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 1C.

The present invention includes a cascade refrigeration system, comprising:
(a) a low stage refrigeration circuit comprising:
   (i) a low stage refrigerant consisting essentially of at least about 60% by weight of HFO-1234yf and at least about 20% by weight of HFC-32; and
   (ii) a compressor;
(b) an inter-circuit heat exchanger in which said low stage refrigerant condenses; and
(c) a high stage refrigeration circuit comprising a high stage refrigerant which: (i) has a Class A1 flammability; and (ii) evaporates at a temperature below said low stage refrigerant condensing temperature; and (iii) comprises at least about 77% by weight of HFO-1234ze (E), wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 2B1.

The present invention includes a cascade refrigeration system, comprising:
(a) a low stage refrigeration circuit comprising:
   (i) a low stage refrigerant consisting essentially of consisting essentially of from about 60% to about 70% by weight of HFO-1234yf and from about 30% to about 40% by weight of HFC-32; and
   (ii) a compressor;
(b) an inter-circuit heat exchanger in which said low stage refrigerant condenses; and
(c) a high stage refrigeration circuit comprising a high stage refrigerant which: (i) has a Class A1 flammability; and (ii) evaporates at a temperature below said low stage refrigerant condensing temperature; and (iii) comprises at least about 77% by weight of HFO-1234ze (E), wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 2B2.

The present invention includes a cascade refrigeration system, comprising:
(a) a low stage refrigeration circuit comprising:
   (i) a low stage refrigerant consisting essentially of R454A;
   (ii) a compressor;
   (iii) a condenser;
   (iv) an evaporator; and
   (v) a suction line heat exchanger connected between the outlet of said evaporator and the inlet of said compressor for transferring heat to the refrigerant entering said compressor;
(b) an inter-circuit heat exchanger in which said low stage refrigerant condenses; and
(c) a high stage refrigeration circuit comprising a high stage refrigerant which: (i) has a Class A1 flammability; and (ii) evaporates at a temperature below said low stage refrigerant condensing temperature; and (iii) comprises at least about 77% by weight of HFO-1234ze (E), wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 2C1.

The present invention includes a cascade refrigeration system, comprising:
(a) a low stage refrigeration circuit comprising:
   (i) a low stage refrigerant consisting of R454A;
   (ii) a compressor;
   (iii) a condenser;
   (iv) an evaporator; and
   (v) a suction line heat exchanger connected between the outlet of said evaporator and the inlet of said compressor for transferring heat to the refrigerant entering said compressor;
(b) an inter-circuit heat exchanger in which said low stage refrigerant condenses; and
(c) a high stage refrigeration circuit comprising a high stage refrigerant consisting essentially of R471A and which evaporates at a temperature below said low stage refrigerant condensing temperature, wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 2C2.

The present invention includes a cascade refrigeration system, comprising:
(a) a low stage refrigeration circuit comprising:
   (i) a low stage refrigerant consisting essentially of R454A;
   (ii) a compressor;
   (iii) a condenser;
   (iv) an evaporator; and
   (v) a suction line heat exchanger connected between the outlet of said evaporator and the inlet of said compressor for transferring heat to the refrigerant entering said compressor;
(b) an inter-circuit heat exchanger in which said low stage refrigerant condenses; and
(c) a high stage refrigeration circuit comprising a high stage refrigerant consisting essentially of R471A and which evaporates at a temperature below said low stage refrigerant condensing temperature, wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 2D1.

The present invention includes a cascade refrigeration system, comprising:
(a) a low stage refrigeration circuit comprising:
   (i) a low stage refrigerant consisting essentially of R454A;
   (ii) a compressor;
   (iii) a condenser;
   (iv) an evaporator; and
   (v) a suction line heat exchanger connected between the outlet of said evaporator and the inlet of said compressor for transferring heat to the refrigerant entering said compressor;
(b) an inter-circuit heat exchanger in which said low stage refrigerant condenses; and
(c) a high stage refrigeration circuit comprising a high stage refrigerant consisting essentially of HFO-1234ze (E) and which evaporates at a temperature below said low stage refrigerant condensing temperature, wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 2D2.

The present invention includes a cascade refrigeration system, comprising:
(a) a low stage refrigeration circuit comprising:
   (i) a low stage refrigerant consisting essentially of R454A;
   (ii) a compressor;
   (iii) a condenser;
   (iv) an evaporator; and
   (v) a suction line heat exchanger connected between the outlet of said evaporator and the inlet of said compressor for transferring heat to the refrigerant entering said compressor;
(b) an inter-circuit heat exchanger in which said low stage refrigerant condenses; and
(c) a high stage refrigeration circuit comprising a high stage refrigerant consisting essentially of R-476A and which evaporates at a temperature below said low stage refrigerant condensing temperature, wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 2D3.

The present invention includes a cascade refrigeration system, comprising:
(a) a low stage refrigeration circuit comprising:
   (i) a low stage refrigerant consisting essentially of R454A;
   (ii) a compressor;
   (iii) a condenser;
   (iv) an evaporator; and
   (v) a suction line heat exchanger connected between the outlet of said evaporator and the inlet of said compressor for transferring heat to the refrigerant entering said compressor;
(b) an inter-circuit heat exchanger in which said low stage refrigerant condenses; and
(c) a high stage refrigeration circuit comprising a high stage refrigerant consisting essentially of R-482A and which evaporates at a temperature below said low stage refrigerant condensing temperature, wherein said high stage refrigerant evaporates in said inter-circuit heat exchanger by absorbing heat from said refrigerant in said low stage refrigeration circuit.

For the purposes of convenience, systems in accordance with this paragraph are sometimes referred to herein as System 2D4.

The present invention also includes a cascade refrigeration system, comprising:
(a) a low stage refrigeration circuit comprising:
   (i) a low stage A2L refrigerant comprising from 63% to 67% by weight of HFO-1234yf and from 33% to 37% by weight of HFC-32; and
   (ii) a compressor;
(b) an inter-circuit heat exchanger in which said low stage refrigerant condenses, preferably within the range of temperatures of from about-5° C. to about −15° C.; and
(c) a high stage refrigeration circuit comprising an A1 refrigerant consisting essentially of R471A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 3A1.

The present invention also includes a cascade refrigeration system, comprising:
(a) a low stage refrigeration circuit comprising:
   (i) a low stage A2L refrigerant comprising from 63% to 67% by weight of HFO-1234yf and from 33% to 37% by weight of HFC-32; and
   (ii) a compressor;
(b) an inter-circuit heat exchanger in which said low stage refrigerant condenses, preferably within the range of temperatures of from about-5° C. to about −15° C.; and
(c) a high stage refrigeration circuit comprising an A1 refrigerant consisting essentially of R1234ze (E), said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 3A2.

The present invention also includes a cascade refrigeration system, comprising:
(a) a low stage refrigeration circuit comprising:
   (i) a low stage A2L refrigerant comprising from 63% to 67% by weight of HFO-1234yf and from 33% to 37% by weight of HFC-32; and
   (ii) a compressor;
(b) an inter-circuit heat exchanger in which said low stage refrigerant condenses, preferably within the range of temperatures of from about-5° C. to about −15° C.; and
(c) a high stage refrigeration circuit comprising an A1 refrigerant consisting essentially of R476A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 3A3.

The present invention also includes a cascade refrigeration system, comprising:
(a) a low stage refrigeration circuit comprising:
   (i) a low stage A2L refrigerant comprising from 63% to 67% by weight of HFO-1234yf and from 33% to 37% by weight of HFC-32; and
   (ii) a compressor;
(b) an inter-circuit heat exchanger in which said low stage refrigerant condenses, preferably within the range of temperatures of from about-5° C. to about −15° C.; and
(c) a high stage refrigeration circuit comprising an A1 refrigerant consisting essentially of R482A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 3A4.

The present invention also includes a cascade refrigeration system, comprising:
(a) a plurality of low stage refrigeration circuits, with each low stage refrigeration circuit comprising:
   (i) a low stage A2L refrigerant comprising from 64% to 66% by weight of HFO-1234yf and from 34% to 36% by weight of HFC-32; and
   (ii) a compressor;
(b) an inter-circuit heat exchanger in which said low stage refrigerant condenses, preferably within the range of temperatures of from about-5° C. to about −15° C.; and
(c) a high stage refrigeration circuit consisting essentially of R471A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 4 A1.

The present invention also includes a cascade refrigeration system, comprising:
(a) a plurality of low stage refrigeration circuits, with each low stage refrigeration circuit comprising:
   (i) a low stage A2L refrigerant comprising from 64% to 66% by weight of HFO-1234yf and from 34% to 36% by weight of HFC-32; and
   (ii) a compressor;
(b) an inter-circuit heat exchanger in which said low stage refrigerant condenses, preferably within the range of temperatures of from about-5° C. to about −15° C.; and
(c) a high stage refrigeration circuit consisting essentially of R1234ze, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 4A2.

The present invention also includes a cascade refrigeration system, comprising:
(d) a plurality of low stage refrigeration circuits, with each low stage refrigeration circuit comprising:
   (i) a low stage A2L refrigerant comprising from 64% to 66% by weight of HFO-1234yf and from 34% to 36% by weight of HFC-32; and
   (ii) a compressor;
(e) an inter-circuit heat exchanger in which said low stage refrigerant condenses, preferably within the range of temperatures of from about-5° C. to about −15° C.; and
(f) a high stage refrigeration circuit consisting essentially of R476A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 4A3.

The present invention also includes a cascade refrigeration system, comprising:
(g) a plurality of low stage refrigeration circuits, with each low stage refrigeration circuit comprising:
   (i) a low stage A2L refrigerant comprising from 64% to 66% by weight of HFO-1234yf and from 34% to 36% by weight of HFC-32; and
   (ii) a compressor;
(h) an inter-circuit heat exchanger in which said low stage refrigerant condenses, preferably within the range of temperatures of from about-5° C. to about −15° C.; and
(i) a high stage refrigeration circuit consisting essentially of R482A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 4A1.

The present invention also includes a cascade refrigeration system, comprising:
(a) a plurality of low stage refrigeration circuits, with each low stage refrigeration circuit comprising:
   (i) a low stage refrigerant consisting essentially of R454A; and
   (ii) a compressor;
(b) an inter-circuit heat exchanger in which said low stage refrigerant condenses, preferably within the range of temperatures of from about-5° C. to about −15° C.; and
(c) a high stage refrigeration circuit comprising an A1 refrigerant consisting essentially of R471A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 4B1.

The present invention also includes a cascade refrigeration system, comprising:
(d) a plurality of low stage refrigeration circuits, with each low stage refrigeration circuit comprising:
   (i) a low stage refrigerant consisting essentially of R454A; and
   (ii) a compressor;
(e) an inter-circuit heat exchanger in which said low stage refrigerant condenses, preferably within the range of temperatures of from about-5° C. to about −15° C.; and

(f) a high stage refrigeration circuit comprising an A1 refrigerant consisting essentially of HFO-1234ze (E), said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 4B2.

The present invention also includes a cascade refrigeration system, comprising:
(a) a plurality of low stage refrigeration circuits, with each low stage refrigeration circuit comprising:
   (i) a low stage refrigerant consisting essentially of R454A and
   (ii) a compressor;
(b) an inter-circuit heat exchanger in which said low stage refrigerant condenses, preferably within the range of temperatures of from about-5° C. to about −15° C.; and
(c) a high stage refrigeration circuit comprising a refrigerant consisting essentially of R476A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 4B3.

The present invention also includes a cascade refrigeration system, comprising:
(a) a plurality of low stage refrigeration circuits, with each low stage refrigeration circuit comprising:
   (i) a low stage refrigerant consisting essentially of R454A and
   (ii) a compressor;
(b) an inter-circuit heat exchanger in which said low stage refrigerant condenses, preferably within the range of temperatures of from about-5° C. to about −15° C.; and
(c) a high stage refrigeration circuit comprising a refrigerant consisting essentially of R482A, said high stage refrigerant evaporating at a temperature below said low stage refrigerant condensing temperature, and preferably in the range of about −5° C. to about −15° C., wherein said high stage refrigerant evaporates in said inter-circuit heat exchanger by absorbing heat from said low stage refrigerant.

For the purposes of convenience, systems in accordance with this paragraph are sometimes referred to herein as System 4B4.

The present invention includes a cascade refrigeration system, including each of Systems 1 through 4, wherein said low stage refrigeration circuit comprises a plurality low stage refrigeration circuits. For the purposes of convenience, systems in accordance with this paragraph are sometimes referred to herein as System 5A.

The present invention includes a cascade refrigeration system, including each of Systems 1 through 4, wherein said low stage refrigeration circuit is located in an area open to the public. For the purposes of convenience, systems in accordance with this paragraph are sometimes referred to herein as System 5B.

The present invention includes a cascade refrigeration system, including each of Systems 1 through 4, wherein said low stage refrigeration circuits comprises a plurality of self-contained low stage refrigeration circuits, with at least two of such low stage circuits being contained in a separate, modular refrigeration unit and each of said modular refrigeration units being located in a first area open to the public. For the purposes of convenience, systems in accordance with this paragraph are sometimes referred to herein as System 5C.

The present invention includes a cascade refrigeration system, including each of Systems 1 through 5, wherein said compressor in each of said low stages has a horsepower rating of about 2 horsepower or less. For the purposes of convenience, systems in accordance with this paragraph are sometimes referred to herein as System 6.

The present invention includes a cascade refrigeration system, including each of Systems 1 through 6, wherein in said inter-circuit heat exchanger said low stage refrigerant condenses within the range of temperatures of from about −5° C. to about −15° C. For the purposes of convenience, systems in accordance with this paragraph are sometimes referred to herein as System 7.

Medium temperature refrigeration systems and methods are also provided by the present invention, as described in detail hereinafter.

Furthermore, Applicants have come to appreciate that in many evaporators, such as direct expansion evaporators, there is a pressure loss as the refrigerant moves through the evaporator, and in many cases the pressure drop is in an amount that results in a saturation temperature drop of from about 1° C. to 2° C.

The methods and systems of the present invention include those capable of utilizing and achieving highly efficient heat exchanger design, especially for applications like reversible heat pumps where the refrigerant flow changes direction in the heat exchanger depending on the mode of operation (cooling or heating).

### BRIEF DESCRIPTION OF THE FIGURES

FIG. 1A represents in schematic form a typical cascade refrigeration system.

FIG. 1B represents in schematic form a typical supermarket produce cooling case.

FIG. 2 shows a cascade refrigeration system useful in accordance with the present invention.

FIG. 3 shows an alternative cascade refrigeration system useful in accordance with the present invention.

FIG. 4 shows a cascade refrigeration system which uses a flooded evaporator.

FIGS. 5A and 5B show refrigeration systems with and without suction line heat exchangers, respectively.

FIG. 6 shows the heat transfer system of Example 5.

FIG. 7 shows the heat transfer system described in Comparative Example 1.

FIG. 8 shows in graphical form the COP results of Example 5 and Comparative Examples 1-4.

FIG. 9 shows the heat transfer system described in Comparative Example 2.

FIG. 10 shows the heat transfer system described in Comparative Example 3.

FIG. 11 shows in graphical form the emissions and the weighted COP results of Example 5 and Comparative Examples 1-4.

FIG. 12 shows in graphical form the system COP for Example 5 and Comparative Examples 1-4 as a function of ambient temperature.

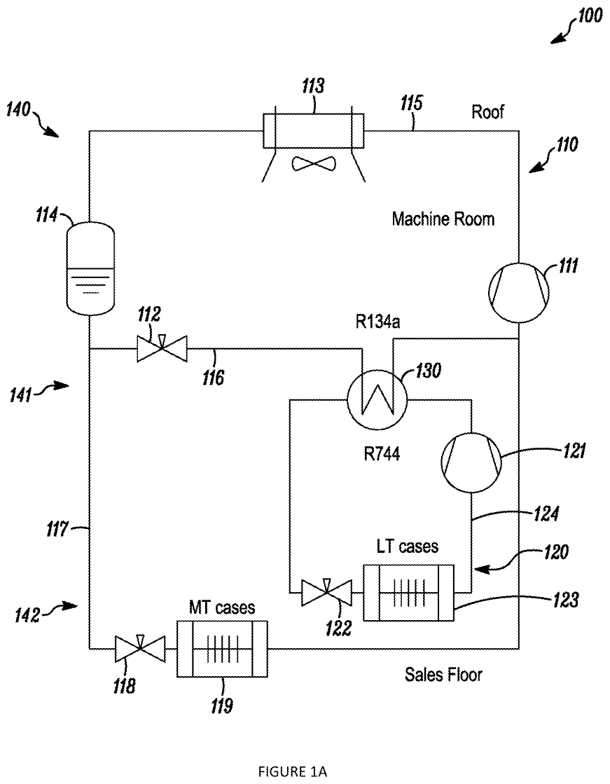

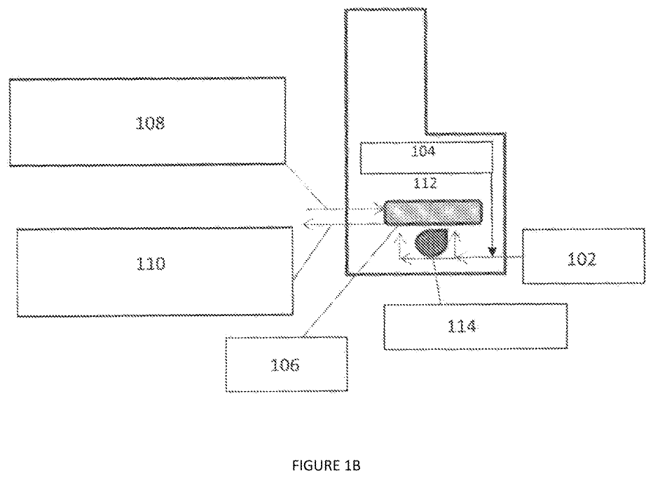

### DESCRIPTION OF PREFERRED COMPOSITIONS

### Definitions

As used herein, the terms “low stage” and “high stage” are used in a relative context to designate the relative evaporation temperatures of two or more cascaded refrigeration circuits. Thus, the term “low stage” in the context of a cascaded refrigeration system refers to the refrigeration circuit in which the refrigerant evaporators at temperature that is less than the evaporation temperature of the refrigerant in the “high stage.”

As used herein, the term “cascaded refrigeration” refers to a refrigeration system having a low stage refrigerant vapor is cooled, and preferably condensed, at least in part by rejecting heat to the high stage refrigerant.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “Global Warming Potential” (hereinafter “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fifth Assessment Report, 20141, referred to and abbreviated herein as AR5.

The term “non-flammable” refers to compounds or compositions which are determined to be nonflammable as determined in accordance with ASTM Standard E-681-2009 Standard Test Method for Concentration Limits of Flammability of Chemicals (Vapors and Gases) at conditions described in ASHRAE Standard 34-2016 Designation and Safety Classification of Refrigerants and described in Appendix B1 to ASHRAE Standard 34-2016 (as each standard exists as of the filing date of this application), which are incorporated herein by reference in its entirety (“Non-Flammability Test”). Flammability is defined as the ability of a composition to ignite and/or propagate a flame. Under this test, flammability is determined by measuring flame angles. A non-flammable substance would be classified as class “1” by ASHRAE Standard 34-2016 Designation and Safety Classification of Refrigerants (as each standard exists as of the filing date of this application). ¹Myhre. G., D. Shindell, F.-M. Bréon. W. Collins, J. Fuglestvedt. J. Huang. D. Koch, J.-F. Lamarque. D. Lec. B. Mendoza, T. Nakajima, A. Robock, G. Stephens, T. Takemura and H. Zhang, 2013: Anthropogenic and Natural Radiative Forcing. In: Climate Change 2013: The Physical Science Basis. Contribution of Working Group I to the Fifth Assessment Report of the Intergovernmental Panel on Climate Change [Stocker. T. F., D. Qin. G.-K. Plattner, M. Tignor, S. K. Allen, J. Boschung, A. Nauels, Y. Xia, V. Bex and P. M. Midgley (eds.)]. Cambridge University Press, Cambridge, United Kingdom and New York, NY, USA. https://www.ipcc.ch/pdf/assessmentreport/ar5/wg1/WG1AR5_Chapter08_FINAL.pdf (p. 73-79)

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase “saturation temperature” means the temperature at which the liquid refrigerant boils into vapor at a given pressure.

The phrase “no or low toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and low toxicity would be classified as “A1” by ASHRAE Standard 34-2016 Designation and Safety Classification of Refrigerants and described in Appendix B1 to ASHRAE Standard 34-2016 (as each standard exists as of the filing date of this application).

The term “degree of superheat” or simply “superheat” means the temperature rise of the refrigerant at the exit of the evaporator above the saturated vapor temperature (or dew temperature) of the refrigerant.

As used herein, the terms R1234yf and HFO-1234yf mean 2,3,3,3-tetrafluoropropene.

As used herein, the terms R1234ze (E), HFO-1234ze (E) and E-1,3,3,3-tetrafluoropropene means the trans isomer of HFO-1234ze.

As used herein, the term “E-1,1,1,4,4,4-hexafluorobut-2-ene” means the trans isomer of HFO-1336mzz and is abbreviated as HFO-1336mzz (E).

As used herein, the term “1, 1,1,2,3,3,3-heptafluoropropane” is abbreviated as HFC-227ea.

As used herein, the term “low temperature refrigeration” refers to a refrigeration system that operates under or within the following conditions: (a) condenser temperature from about 15° C. to about 50° C.; and (b) evaporator temperature from about −40° C. to about or less than about −15° C.

As used herein, the term “medium temperature refrigeration” refers to a refrigeration system that utilizes one or more compressors and operates under or within the following conditions: (a) a condenser temperature of from about 15° C. to about 60° C.; and (b) evaporator temperature of from about −15° C. to about 5° C.

As used herein the term “extreme temperature air conditioning system” means a vapor compression air conditioning system in which the condensing temperature of the refrigerant is from about 55° C. to about 95° C.

As used herein the term “high temperature heat pump system” means a vapor compression system operable in a heating mode in which the condensing temperature of the refrigerant is from about 55° C. to about 95° C.

As used herein, the term “R454A” means the refrigerant designated by ASHRAE as 454A and which consists of 35% (preferably +1/−1%) of R-32 and 65% (preferably +1/−1%) of HFC-1234yf.

As used herein, the term “R454C” means the refrigerant designated by ASHRAE as 454C and which consists of 21.5%+2/−2% of R-32 and 78.5-+2/−2% of HFC-1234yf.

As used herein, the term “R455A” means the refrigerant designated by ASHRAE as 455AC and which consists of 21.5%+2/−1% of R-32, 75.5 of HFC-1234yf+2/−2% and 3%+2/−1% of CO2.

As used herein, the term “R471A” means the refrigerant designated by ASHRAE as 471A and which consists of 78.7%+0.4/−1.5% of HFC-1234ze (E), 17%+1.5/−0.4% of HFC-1336mzz (E) and 4.3%+1.5/−0.4% of HFC-227ea.

As used herein, the term “R476A” means the refrigerant designated by ASHRAE as 476A and which consists of 78.7%+/−0.5/−2% of HFC-1234ze (E), 12%+2/−0.5% of HFC-1336mzz (E) and 10%+2/−0.51% of HFC-134a.

As used herein, the term “R482A” means the refrigerant designated by ASHRAE as 482A and which consists of 10% 134a, 83.5 of HFC-1234ze (E), 6.5 1224 yd.

As used herein, the term “about” in relation to the amount expressed in weight percent means that the amount of the component can vary by an amount of +/−2% by weight.

### Cascade Systems

The present invention includes cascade refrigeration systems, including each of Systems 1-7, in which said inter-circuit heat exchanger is a flooded heat exchanger in which said high stage refrigerant evaporates in said heat exchanger by absorbing heat from said low temperature refrigerant. As used herein, reference to a numbered system or group of numbered systems that have been defined herein means each of such numbered systems, including each system having a number within the group, including any suffixed numbered system. For example, reference to System 1 includes reference to each of Systems 1A, 1B and 1C.

As the term is used herein, “flooded heat exchanger” refers to a heat exchanger in which a liquid refrigerant is evaporated to produce refrigerant vapor with no substantial super heat. As the term is used herein, “no substantial super heat” means that the vapor exiting the evaporator is at a temperature that is not more than 1° C. above the boiling temperature of the liquid refrigerant in the heat exchanger.

The present invention also includes a cascade refrigeration system, including each of the Systems 1-7, in which the low stage refrigeration circuit comprises one or more of, and preferably a plurality of, low temperature refrigeration circuits.

The present invention also includes a cascade refrigeration system, including each of the Systems 1-7, in which the low stage refrigeration circuit comprises one or more of, and preferably a plurality of, low temperature refrigeration circuits and in which the high stage refrigeration circuit comprises one or more medium temperature refrigerant circuits.

In preferred embodiments, including in each of Systems 1-7, the high stage refrigeration circuit is located substantially completely outside of said low stage refrigeration unit(s). As used herein, the term “substantially completely outside” means that the components of the high stage are generally located remote from said components of the low stage refrigeration units, except that transport piping and the like which may be considered part of the high stage circuit can pass into or located near or among the low stage circuit in order to provide heat exchange between the refrigerant of the low stage and the refrigerant of the high stage via the inter-circuit heat exchanger.

In preferred embodiments, including in each of Systems 1-7, the low stage circuit comprises one or more “refrigeration units,” and preferably “low temperature refrigeration units.” As used herein, the term “refrigeration unit” means an at least partially closed and/or fully closable structure that is capable of providing cooling within at least a portion of that structure and which is structurally distinct from any structure enclosing or containing the high stage circuit.

In preferred embodiments, including in each of Systems 1-7, the high stage circuit comprises one or more “refrigeration units,” and preferably “medium temperature refrigeration units.”

The high stage circuit in the cascade systems of the present invention, including in each of Systems 1-7, may further comprise a fluid receiver for receiving high stage refrigerant from the condenser in the high stage circuit.

Each refrigeration unit including in each of Systems 1-7, may be located within a first area. The first area may be a shop floor. This means that each first refrigeration circuit (preferably low temperature refrigeration circuit) may also be located within a first area, such as a shop floor.

Each refrigeration unit, including in each of Systems 1-7, may comprise a space and/or objects contained within a space to be chilled, and preferably that space is within the refrigeration unit. Each evaporator in the low stage of such preferred refrigeration units may be located to chill its respective space/objects, preferably by cooling air within the space to be chilled.

As mentioned above, the high stage refrigeration circuit of the present invention, including in each of Systems 1-7, and preferably when the high stage circuit comprises a medium temperature refrigeration circuit, may have components thereof that extend between the first low stage circuit (preferably low temperature refrigeration unit) and at least a second area remote from said low stage circuit. The second area may be, for example, a machine room which houses a substantial portion of the components of the high stage circuit.

The high stage refrigeration circuit of the preset invention, including each of Systems 1-7, (preferably comprising medium temperature refrigeration circuits) may extend to a second and a third area. The third area may be an area outside of the building or buildings in which the low stage circuit is located. This allows for ambient cooling to be exploited.

Unless otherwise indicated herein for a particular embodiment, the refrigerant in the high stage circuit may be non-flammable, that is, classified as A1 under ASHRAE 34 (as measured by ASTM E681) or classified as A2L under ASHRAE 34 (as measured by ASTM E681). This may be desirable in those cases in which the high stage circuit includes long runs of piping that extend between different areas of a building: for example, between a shop floor (where low stage refrigeration units might be deployed) to a machine room. Consequently, it may be unsafe to have a flammable refrigerant in the high stage refrigeration circuit since both the risk of leaks and the severity of potential leaks is increased as the high stage circuit spans a greater area and therefore exposes more people and/or structures to risk of fire.

Each low stage refrigeration circuit, including in each of Systems 1-7, may comprise at least one fluid expansion device. The at least one fluid expansion device may be a capillary tube or an orifice tube. This means that simpler flow control devices, such as capillary and orifice tubes, can be and preferably are used to advantage in the low stage refrigeration circuit of the present invention, including each of Systems 1-7.

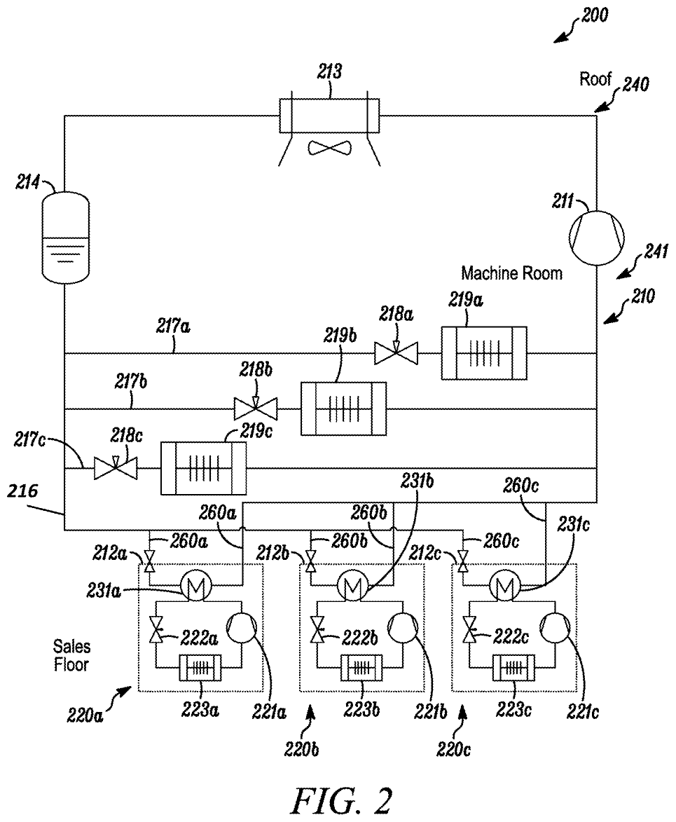

One embodiment of a cascade refrigeration system according to the present invention is illustrated schematically in FIG. 2 and described in detail below.

FIG. 2 shows a cascade refrigeration system 200. More specifically, FIG. 2 shows a refrigeration system 200 which has three low stage refrigeration circuits 220a, 220b and 220c. Each of the low stage refrigeration circuits 220a, 220b, 220c has an evaporator 223, a compressor 221, a heat exchanger 230 and an expansion valve 222. While each of the compressors, evaporators and heat exchangers in the circuit are illustrated by a single icon, it will be appreciated that the compressor, the evaporator, the heat exchanger, expansion valve, etc. can each comprise a plurality of such units. In each circuit 220a, 220b and 220c, the evaporator 223, the compressor 221, the heat exchanger 230 and the expansion valve 222 are connected in series with one another in the order listed. Each of the low stage refrigeration circuits 220a, 220b and 220c is included within a separate respective refrigeration unit (not shown). In this example, each of the three refrigeration units is preferably a freezer unit and the freezer unit houses a respective low temperature refrigeration circuit. In this way, each refrigeration unit comprises a self-contained and dedicated low temperature refrigeration circuit. The refrigeration units (not shown), and therefore the low temperature refrigeration circuits 220a, 220b, 220c, may be arranged, for example, arranged on a sales floor 242 of a supermarket.

In this example, the refrigerant in each of the low stage refrigeration circuits 220a, 220b, 220c is a low GWP refrigerant such as CO2, propane, HFO-1234yf, R454A, R454C, R455A or a combination of two or more of these. As the skilled person will appreciate, the refrigerants in each of the low stage circuits 220a, 220b,220c may be the same or different to the refrigerants in each other of the low stage refrigeration circuits 220a, 220b, 220c, but in a preferred embodiment each of the plurality of low stage circuits contains CO2, propane, HFO-1234yf, R454A, R454C, R455A or a combination of two or more of these.

The refrigeration system 200 also has a high stage refrigeration circuit 210. The high stage circuit 210 has a compressor 211, a condenser 213 and a fluid receiver 214. The compressor 211, the condenser 213 and the fluid receiver 214 are connected in series and in the order given. While each of the compressors, condensers, fluid receivers, etc. in the high stage circuit are illustrated by a single icon, it will be appreciated that the compressor, the evaporator, the heat exchanger, expansion valve, etc. can each comprise a plurality of such units. The high stage refrigeration circuit 210 also has four parallel connected branches: three medium temperature cooling branches 217a, 217b and 217c, which are not in heat transfer communication with the low stage; and low stage cooling branch 216. The four parallel connected branches 217a, 217b, 217c and 216 are connected between the fluid receiver 214 and the compressor 211. Each of the medium temperature cooling branches 217a, 217b and 217c has an expansion valve 218a, 218b and 218c and an evaporator 219a, 219b and 219c, respectively. The expansion valve 218 and evaporator 219 are connected in series and in the order given between the fluid receiver 214 and the condenser 211. The high stage circuit 220, which in preferred embodiments comprises a low temperature cooling branch, 216 has an expansion valve 212 and an interface, in the form of inlet and outlet piping, conduits, valves and the like (represented collectively as 260a, 260b and 260c, respectively) which bring the high stage refrigerant liquid to and high stage refrigerant vapor from each of the inter-circuit heat exchangers 230a, 230b, 230c, which as shown in a preferred embodiment are located within the refrigeration unit 220. The low temperature cooling branch 216 interfaces each of the inter-circuit heat exchangers 230a, 230b, 230c at a respective circuit interface location 231a, 231b, 231c. Each circuit interface location 231a, 231b, 231c is arranged in series-parallel combination with each other of the circuit interface locations 231a, 231b, 231c.

The high stage refrigeration circuit 210 has components which extend between the sales floor 242, a machine room 241 and a roof 140. The cooling branch 216 and the medium temperature branches 218a, 218b, 218c of the medium temperature refrigeration circuit 210 are preferably located on the sales floor 242. The compressor 211 and the fluid receiver 214 are preferably located in the machine room 241. The condenser 213 is preferably located where it can be readily exposed to ambient conditions, such as on the roof 240.

In this example, the refrigerant in the high stage refrigeration circuit 210 comprises, consists essentially of, or consists of a refrigerant that comprises at least about 75% by weight of HFO-1234ze and has a Class A1 or A2L flammability. The present invention includes cascade systems in which the refrigerant in the high stage refrigeration circuit 210 comprises, consists essentially of, or consists of HFO-1234ze (E), R471A and/or R476A and/or R482A. Further advantageously, the blend has a low GWP, making it an environmentally friendly solution, as well as excellent heat transfer performance properties, as illustrated below in the Examples hereof.

Use of the preferred embodiments as illustrated in FIG. 2 can be summarized as follows:
each of the low stage refrigeration circuits 220a, 220b, 220c absorbs heat via their evaporators 223 to provide low temperature cooling to a space to be chilled (not shown);
the high stage refrigeration circuit 210, via branch 216, absorbs heat from each of the inter-circuit heat exchangers 230a, 230b, 230c to cool the condense the low stage refrigerant vapor from the respective compressors in each of low stage circuits 220a, 220b, 220c;
the high stage refrigeration circuit 210 absorbs heat at each of the evaporators 219 to provide medium temperature cooling to spaces to be chilled (not shown); and
heat is removed from the refrigerant in the high stage refrigeration circuit 210 in the air-cooled chiller 213.

A number of beneficial results can be achieved using arrangements of the present invention of the type shown in FIG. 2, particularly from each refrigeration circuit 230 being self-contained in a respective refrigeration unit.

For example, installation and uninstallation of the refrigeration units and the overall cascaded refrigeration system 200 is simplified. This is because the refrigeration units, with their built-in, self-contained refrigeration circuits 220a, 220b, 220c, can be easily connected or disconnected with the high stage refrigeration circuit 210, with no modification to the refrigeration circuit 220, 220b, 220c required. In other words, the refrigeration units may simply be ‘plugged’ in to, or out of, the high stage refrigeration circuit 210.

Another advantage is that each refrigeration unit, including its respective first refrigeration circuit 220a, 220b, 220c, can be factory tested for defaults before being installed into a live refrigeration system 200. This mitigates the likelihood of faults, which can include leaks of potentially harmful refrigerants. Accordingly, a reduced leak rate can be achieved.

Another advantage in preferred embodiments is the provision of a flooded inter-circuit heat exchanger which in systems of the present invention, including each of Systems 1-7, results in improved heat transfer between the low stage and the high stage. Accordingly, the efficiency of the overall refrigeration system is improved.

In preferred embodiments, including each of Systems 1-7, the present invention also includes a cascaded refrigeration system, comprising: a plurality of low temperature refrigeration circuits, with each low temperature refrigeration circuit comprising a low temperature refrigerant having a GWP of about 150 or less and comprising at least about 50% by weight, or at least about 60% by weight by weight of R1234yf, including specifically R-454A, or R454A and in addition one or more of R-454C and/or R455A, and a compressor having a work output of about 3.5 kilowatts or less, an inter-circuit heat exchanger in which said low temperature refrigerant condenses in the range of temperatures of from about −5° C. to about −15° C.; and a medium temperature refrigeration circuit containing medium temperature refrigerant, wherein said medium temperature refrigerant comprises, consists essentially of, or consists of at least about 75% by weight of HFO-1234ze (E), including particularly R471A and/or R476A and/or R482A, and an evaporator in which said medium temperature refrigerant evaporates at a temperature below said low temperature refrigerant condensing temperature and in the range of about −5° C. to about −15° C., wherein said medium temperature refrigerant evaporates in said heat exchanger by absorbing heat from said low temperature refrigerant.

In preferred embodiments, including each of Systems 1-7, the present invention also includes a cascaded refrigeration system, comprising: a plurality of low temperature refrigeration circuits, with each low temperature refrigeration circuit comprising a low temperature refrigerant having a GWP of about 150 or less and comprising at least about 50% by weight, or at least about 60% by weight by weight of R1234yf, including specifically R454A and R454A in combination with R-454C and/or R-455A, and a compressor having a compressor rating of two horse power or less, an inter-circuit heat exchanger in which said low temperature refrigerant condenses in the range of temperatures of from about −5° C. to about −15° C.; and a medium temperature refrigeration circuit containing medium temperature refrigerant, wherein said medium temperature refrigerant comprises, consists essentially of, or consists of at least about 75% by weight of HFO-1234ze (E), including particularly R471A and/or R476A and/or R482A, and an evaporator in which said medium temperature refrigerant evaporates at a temperature below said low temperature refrigerant condensing temperature and in the range of about −5° C. to about −15° C., wherein said medium temperature refrigerant evaporates in said heat exchanger by absorbing heat from said low temperature refrigerant.

### Cascade Refrigeration System—Alternatives

As the person skilled in the art will appreciate in view of the teachings contained here, there may be in accordance with the present invention, including each of Systems 1-7, any number of low stage refrigeration circuits 220. In particular, there may be as many low stage circuits 220 as there are refrigeration units to be cooled. Accordingly, the high stage refrigeration circuit 210 may be interfaced with any number of low stage refrigeration circuits 220, and visa-versa.

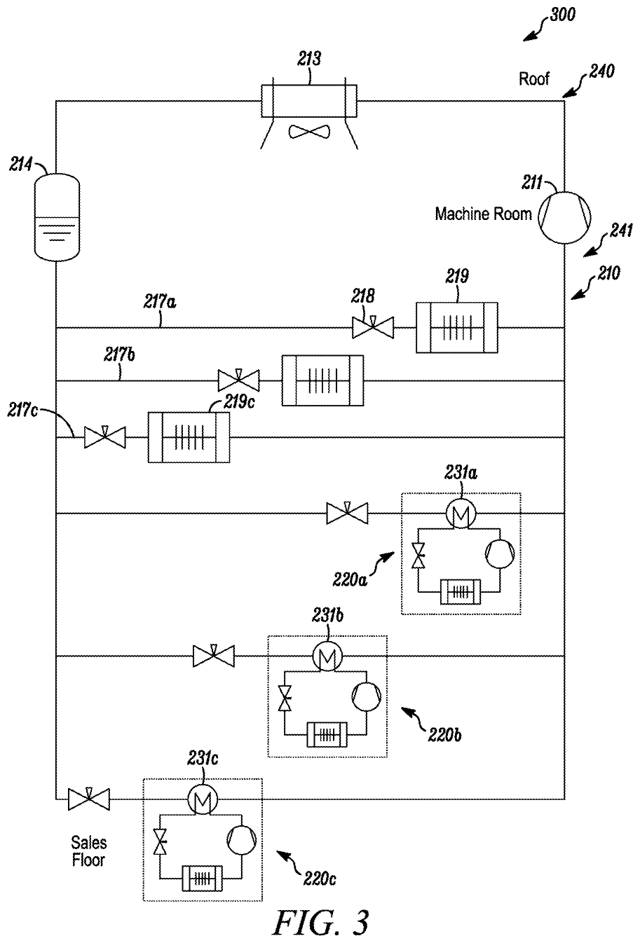

As will be clear to the skilled person in view of the teachings contained here, there may be in accordance with the present invention, including each of Systems 1-4, any number and arrangement of high stage circuit branches 217 and evaporators 218. In alternative arrangements in accordance with the present invention, including each of Systems 1-7, each low stage circuit 220 may be arranged fully in parallel with each other low stage circuit 220. An example of such an arrangement is shown in FIG. 3. FIG. 3 shows a system 300 where each circuit interface location is present in inter-circuit heat exchangers 231a, 231b, 231c is arranged fully in parallel with each other circuit interface location. The components of the system 300 are otherwise the same as in system 200 (described in reference to FIG. 2), and components of the system 300 function in substantially the same way as the system 200, although it will be appreciated that the performance of the overall system and other important features of the overall system can be significantly impacted by this change in the arrangement.

Usefully, this means that a given portion of refrigerant from the high stage circuit 210 only passes through one inter-circuit heat exchanger 230 before it is returned to the compressor 211. This arrangement thus ensures that each of the heat exchangers 230 will receive high stage refrigerant at about the same temperature, since the arrangement prevents any of the heat exchangers from receiving a portion of the refrigerant that is pre-warmed as a result of passing through an upstream heat exchanger, as would be the case in a series arrangement.

As will be clear to the person skilled in the art in view of the teachings contained here, many other arrangements of the circuit interface locations 231a, 231b, 231c with respect to one and the high stage refrigeration circuit 210 can be achieved in accordance with the present invention, including each of Systems 1-7, and indeed are envisaged.

As will be clear to the person skilled in the art in view of the teachings contained here, by virtue of the preferred modular design of the low stage circuits of the preferred embodiments of the present invention, including each of Systems 1-7, allows use of non-flammable, low-pressure refrigerants with relatively low GWP.

Cascaded Refrigeration System with Flooded Evaporator

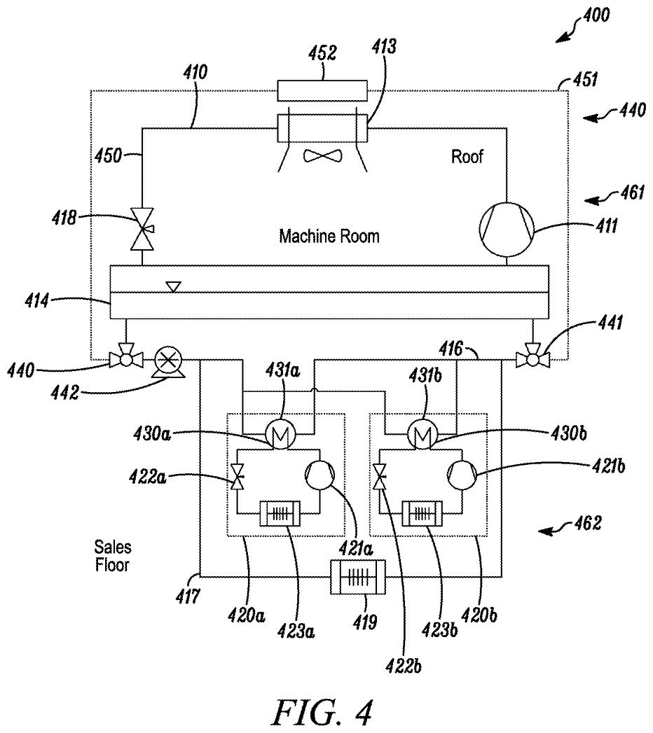

A preferred refrigeration system of the present invention is exemplified and will now be described with reference to FIG. 4, which schematically shows a cascaded refrigeration system 400 with a high stage refrigeration circuit 410 that has a receiver 414 that delivers liquid refrigerant, which results in flooded evaporator operation in the inter-circuit heat exchangers 431. More specifically, FIG. 4 shows a refrigeration system 400 which has two low stage refrigeration circuits 420a, 420b. Each of the low stage refrigeration circuits 420a, 420b has an evaporator 423, a compressor 421, an inter-circuit heat exchanger 431 and an expansion valve 422. In each circuit 420a, 420b, the evaporator 423, the compressor 421, the heat exchanger 430 and the expansion valve 422 are connected in series with one another in the order listed. Each of the first refrigeration circuits 420a, 420b is preferably provided in a respective refrigeration unit (not shown). In a preferred example, each low stage refrigeration circuit is included in a freezer unit and the freezer unit houses its respective low stage refrigeration circuit. In this way, a self-contained and dedicated refrigeration circuit is provided to each refrigeration unit. The refrigeration units (not shown), and therefore the low stage refrigeration circuits 420a, 420b are located in preferred embodiments on a sales floor 462 of a supermarket.

The receiver 414 is arranged to separate the gaseous and liquid refrigerant after it has passed through the expansion valve 418 such that the refrigerant allowed through to the medium 417 and low 416 temperature cooling branches—and therefore through to the evaporator 419 and heat exchangers 430a, 430b—is essentially 100% liquid. Another key feature of the refrigeration system 400 is the pump 442. The pump 442 drives the refrigerant to the medium 417 and low 416 temperature branches. In alternative system arrangements, the density difference between the liquid and gaseous phases of the refrigerant drives the system and no pump or fan is required.

In this example, the low stage refrigerant in refrigeration circuits 420a and 420b comprises, consists essentially of or consists of, a low GWP, non-flammable (Class A1) refrigerant, comprising at least about 50% by weight, or at least about 60% by weight by weight of R1234yf, including specifically R-454A or R454A in combination with R-454C and/or R455A. As the skilled person will appreciate, the refrigerants in each of the refrigeration circuits 420a, 420b may be the same or different to the refrigerants in the other of the first refrigeration circuits 420a, 420b.

The refrigeration system 400 also has a high stage refrigeration circuit 410 which has a compressor branch 450 and an ambient cooling branch 451. The compressor branch 450 is connected in parallel with the ambient cooling branch 451. The compressor branch 450 has a compressor 411, a condenser 413, an expansion valve 418 and a receiver 414. The compressor 411, the condenser 413 and the expansion valve 418 are connected in series and in the order given. The receiver 414 is connected between the compressor 411 inlet and the expansion valve 418 outlet. The ambient cooling branch 451 has a chiller 452.

The compressor branch 450 and the ambient cooling branch 451 are connected in parallel by first 440 and second 441 controllable valves. The controllable valves 440, 441 are controllable such that the amount of refrigerant flowing in each of the compressor branch 450 and the ambient cooling branch 451 is controllable. The first control valve 440 is connected in series with a pump 442.

The high stage refrigeration circuit 410 also has two further branches which are connected in parallel with one another: a medium temperature cooling branch 417 and a low temperature cooling branch 416 which provides liquid refrigerant to the inter-circuit heat exchangers 431. The medium temperature cooling branch 417 and the branch 416 are connected between the pump 442 and the second controllable valve 441. The medium temperature cooling branch 417 has an evaporator 419. The low temperature cooling branch 416 interfaces each of the inter-circuit heat exchangers 430a, 430b of the first refrigeration circuits 420a, 420b at a respective circuit interface location 431a, 431b. Each of the circuit interface locations 431a, 431b is in series-parallel combination with the other circuit interface location 431a, 431b.

The cascade system 400 includes components that extend the high stage circuit and the low stage circuit between the sales floor 462, a machine room 461 and a roof 440. The branch 416 which brings high stage liquid refrigerant to the inter-circuit heat exchanger, and the medium temperature cooling branch 417, are preferably each located primarily on the sales floor 462. By primarily arranged on the sales floor 462, it is meant that the circuit locations 431a, 431b and the evaporator 419 are arranged on or very near the sales floor 462. The junction between the low 416 and medium 417 temperature cooling branches and some of the pipes of the low 416 and medium 417 branches may, however, be located in the machine room 461.

The compressor branch 450 in preferred embodiments includes components that extend the branch between the machine room 461 and the roof 460. More specifically, the compressor 411, the expansion valve 418 and the flooded receiver 414 are preferably located in the machine room 461. The condenser 413 is preferably located where ready access to ambient air is possible, such as on the roof 460.

The ambient cooling branch 450 preferably includes components that extend the branch between the machine room 461 and the roof 460. The chiller 452 is also located where ready access to ambient air is possible, such as on the roof 603.

The first and second controllable valves 440, 441 are preferably located in the machine room 461. The pump 442 is preferably located in the machine room 442.

In this example, the refrigerant in the high stage circuit 410 preferably comprises, consists essentially of, or consists of at least about 75% by weight of HFO-1234ze (E), including particularly R471A and/or R476A and/or 482A.

Though structurally different, in use, the refrigeration system 400 operates in a similar manner to refrigeration system 200 with the following key differences. Firstly, the receiver in the high stage refrigeration circuit 410 in the refrigeration system 400 results in inter-circuit heat exchangers 430a and 430b being flooded evaporators for the high stage circuit, and the medium temperature evaporator 419 is also a flooded evaporator.

As the skilled person will appreciate based on the disclosure and teaching contained herein, there are several advantages associated with using a refrigeration arrangement in accordance with the present invention, including each of Cascade Systems 1-7, which uses a flooded evaporator, as disclosed for example in system 400.

Applicants have found that one such advantage is an unexpected improvement in the coefficient of performance (COP). Without necessarily being bound to any particular theory, it is believed that this advantage, which is unexpected, arises in part because less compressor 411 work is required and the cooling capacity of the second refrigeration circuit 410 is improved because the system allows operation with superheating the refrigerant before it enters the compressor.

A second difference in the way the refrigeration system 400 operates compared to the refrigeration system 200 lies in the provision of the ambient cooling branch 451 and controllable valves 440,441. The ambient cooling branch 451 allows the compressor branch 450 to be bypassed when the ambient temperature is sufficiently low to chill the refrigerant. This is achieved by routing the ambient cooling branch 451 to the roof 460 to provide maximum exposure of the refrigerant to the ambient air temperature. This is sometimes called winter operation. Usefully, this provides essentially free chilling of the refrigerant in the second refrigeration circuit 410. Clearly this is advantageous both from a cost and environmental perspective as energy consumption is greatly reduced as compared to running the compressor branch 450.

For the purposes of convenience, the term “flooded system,” “flooded cascade system,” and the like refer to systems of the present disclosure in which at least one and preferably all of the heat exchangers in the low stage refrigeration circuit (preferably low temperature circuit) for condensing the low stage refrigerant (preferably medium temperature refrigerant) are flooded evaporators for the high stage refrigerant (preferably the medium temperature refrigerant). In preferred embodiments in accordance with the present invention, including each of Systems 1-7, the medium temperature evaporator is also a flooded evaporator. The potential advantages described in reference to the cascaded refrigeration system apply equally well to the flooded cascaded refrigeration system: the terms used to describe the flooded and non-flooded cascaded refrigeration system being comparable.

Further advantages of the flooded cascaded refrigeration system in accordance with the present invention, including each of Systems 1-7, can include: reduced energy consumption due to exploitation of the ambient cooling branch (winter operation); improved heat transfer performance in the heat exchangers and evaporators due to their flooded operation; no thermostatic expansion valves are required due to the provision of a pump in the circuit; and low cost materials can be used to manufacture the second refrigeration circuit due to it being suitable for low pressure refrigerant.

Particularly in view of the advantages described herein, the present invention including each of Systems 1-7, includes a cascaded refrigeration system, comprising: a plurality of low stage refrigeration circuits, with each low stage refrigeration circuit comprising a first refrigerant comprises, consists essentially of or consists of, a low GWP, non-flammable (Class A1) refrigerant, comprising at least about 50% by weight, or at least about 50% by weight by weight of R1234yf, including specifically R454A and R454A in combination with R-454C and/or R455A, a compressor having a horse power rating of about 2 horse power or less, and an inter-circuit heat exchanger in which said low stage refrigerant condenses; and a high stage refrigeration circuit containing a high stage refrigerant which comprises, consists essentially of, or consists of at least about 75% by weight of HFO-1234ze (E), including particularly R471A and/or R476A and/or R482A, and a flooded evaporator in which said high stage refrigerant evaporates at a temperature below said low stage refrigerant condensing temperature wherein said high stage refrigerant evaporates in said inter-circuit heat exchanger by absorbing heat from said first refrigerant.

### Flooded Cascade Refrigeration System—Alternatives

The alternatives described above in reference to the cascaded refrigeration system apply equally well to the flooded cascaded refrigeration system. Other alternatives include removal of the ambient cooling branch 451 and/or reversion of the flooded system to a direct expansion system. A yet further alteration of the system 400, including each of Systems 1-7, which is envisaged is that the ambient cooling branch 451 may be shortened and simplified such that it only bypasses the compressor 411, rather than the entire compressor branch.

Advantageously, the use of a shortened ambient chilling branch, that is, one in which the branch routes liquid refrigerant from receiver outlet to the condenser inlet results in: first, a simplified circuit as the chiller and first controllable valve at the inlet of the receiver pump are no longer required; and second, a lower cost circuit, since the amount of extra piping for the ambient chilling branch and the number of components is reduced, therefore reducing material costs.

### Suction Line Heat Exchanger

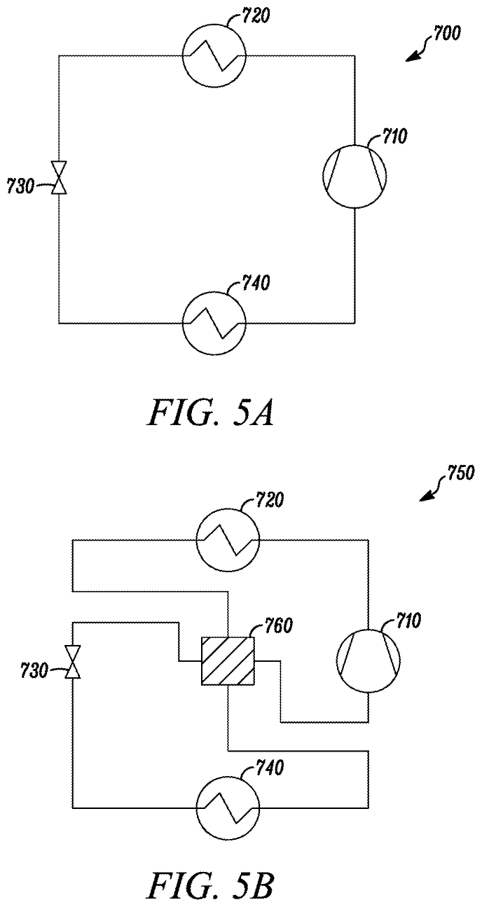

A further possible alteration of any of the systems forming part of this disclosure including each of Systems 1-7, is that any number of the self-contained refrigeration circuits may include a suction line heat exchanger (SLHX). More specifically, any of the low stage refrigeration circuits 220a, 220b, 220c in system 200, including each of Systems 1-7, may include an SLHX; and any of the low stage refrigeration circuits 420a, 420b may include an SLHX. For comparison, FIG. 5A shows a refrigeration circuit 700 without a SLHX; while FIG. 5B shows a refrigeration circuit 750 with a SLHX 760.

The circuit 700 in FIG. 5A has a compressor 710, a heat exchanger 720, an expansion valve 730 and an evaporator 740. The compressor 710, the heat exchanger 720, the expansion valve 730 and the evaporator 740 are connected in series and in the order listed. In use, the refrigeration circuit 700 functions as previously described.

The circuit 750 in FIG. 5B has the same components as the circuit 700, plus an additional SLHX 760. The SLHX provides a heat exchange interface between the line connecting the evaporator 740 and the compressor 710, and the line connecting the heat exchanger 720 and the expansion valve 730. In other words, the SLHX 760 is positioned between the line connecting the evaporator 740 and the compressor 710 (herein referred to as the vapor line), and the line connecting the heat exchanger 720 and the expansion valve 730 (herein referred to as the liquid line). In use, the SLHX transfers heat from the liquid line, after the heat exchanger 720, to the vapor line, after the evaporator 740. This results in two effects taking place: a first which improves the efficiency of the circuit 700; and a second which reduces the efficiency of the circuit 700. Firstly, advantageously, on the liquid line side—that is, the high-pressure side—the sub-cooling of the liquid refrigerant is increased. This is because extra heat is rejected to the liquid expansion side, which reduces the temperature of the refrigerant entering the expansion valve 730. This additional sub-cooling leads to lower inlet quality in the evaporator 740 after the expansion valve 730 process. This increases the enthalpy difference and so the capacity of the refrigerant to absorb heat in the evaporator 740 stage is increased. Accordingly, the performance of the evaporator 740 is improved.

Secondly, disadvantageously, on the vapor line side—that is, the low-pressure side—the refrigerant exiting the evaporator 740 receives extra heat from the liquid line, which effectively increases the superheating. This results in a higher suction line temperature. As a result of the higher suction line temperature to the compressor 710, the enthalpy difference of the compression process increases. This increases the compressor power required to compress the refrigerant. Accordingly, this has a detrimental effect on the system performance.

In summary, both the first and second effects of improved evaporator capacity and improved compressor power requirements need to be considered in order to determine whether or not introducing a SLHX results in an overall beneficial effect. Generally, the use of a SLHX in accordance with the present invention, including each of Systems 1-7 and in particular such systems 200 and 300 herein, leads to an overall positive and unexpectedly beneficial effect.

The high stage refrigeration circuit, including in each of Systems 1-4, may comprise a second evaporator. The second evaporator may be coupled in parallel with the circuit interface locations.

Each of the circuit interface locations, including in each of Systems 1-4, may be coupled in series-parallel combination with each other of the circuit interface locations. Usefully, this means that if one of the circuit interface locations, first refrigeration circuits, or first refrigeration units has a fault or blockage detected, the location, circuit or unit at fault can be isolated and/or bypassed by the second refrigeration circuit so that faults do not propagate through the system.

Each of the circuit interface locations, including in each of Systems 1-7, may be coupled in series with at least one other circuit interface location.

Each of the circuit interface locations, including in each of Systems 1-7, may be coupled in series with each other of the circuit interface locations.

Each of the circuit interface locations, including in each of Systems 1-7, may be coupled in parallel with at least one other circuit interface location.

Each of the circuit interface locations, including in each of Systems 1-7, may be coupled in parallel with each other of the circuit interface locations.

### Refrigerant Compositions

### HFO-1234ze (E), HFO-1336mzz (E) and HFC-227ea

The present invention provides a refrigerant which may comprise, consist essentially of, or consist of HFO-1234ze (E), HFO-1336mzz (E), and HFC-227ea, and such a refrigerant is particularly useful as the high stage refrigerant of the preferred cascade systems of the present invention, including particularly Systems 1-7.

### Lubricants:

Preferably, the heat transfer compositions of the present invention may include any of the above noted refrigerants and additionally a lubricant. The lubricant when present is used to lubricate the refrigeration compressor using the refrigerant. Preferably the lubricant is present in the heat transfer composition in amounts of from about 1% to about 50% by weight of heat transfer composition, more preferably in amounts of from about 10% to about 50% by weight of the heat transfer composition, and most preferably about 30% to about 50% by weight of the heat transfer composition. Useful lubricants include, alkyl benzenes, esters, polyol esters (“POEs”), poly alkylene glycols (“PAGs”), polyvinyl ethers (“PVEs”), poly(alpha-olefin) (“PAOs”), and combinations thereof. Commercially available alkyl benzene lubricants include Zerol 150 (registered trademark). PAGs are available as GM Goodwrench Refrigeration Oil and MOPAR-56. Other useful esters include phosphate esters, dibasic acid esters, and fluoroesters.

Commercially available POEs include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H have the properties identified in the following table:

| Property | RL32-3MAF | RL68H |
|---|---|---|
| Viscosity @ 40° C. (ASTM D445), cSt | about 31 | about 67 |
| Viscosity @ 100° C. (ASTM D445), cSt | about 5.6 | about 9.4 |
| Pour Point (ASTM D97), ° C. | about −40 | about −40 |

Commercially available PVE's include the polyvinylethers FVC-32D (registered trademark) and FVC-68D (registered trademark) by Idemitsu.

Preferred lubricants include POEs and PVEs, more preferably POEs. Of course, different mixtures of different types of lubricants may be used.

The heat transfer composition of the present invention may consist essentially of or consist of a refrigerant and lubricant, including in particular each of the preferred lubricants as described above.

The present invention also includes, and provides particular advantage in connection with, medium temperature refrigeration systems with two-stage vapor injected compression that include refrigerants of the present invention.

The present invention also includes, and provides particular advantage in connection with, vending machines, including with suction line/liquid line heat exchanger, that include refrigerants of the present invention.

The present invention also includes, and provides particular advantage in connection with, air-source heat pump water heaters, including with suction line/liquid line heat exchanger, that include refrigerants of the present invention.

The present invention also includes, and provides particular advantage in connection with, air conditioning systems, including mobile, residential and commercial air conditioning systems, that include refrigerants of the present invention.

### EXAMPLES

In the examples which follow, the refrigerant compositions which are the subject of one or more examples are identified in the example. Each of the refrigerants was subjected to thermodynamic analysis to determine its ability to match the operating characteristics of R-404A in various refrigeration systems. The analysis was performed using experimental data collected for properties of various binary and ternary pairs of components used in the refrigerant. The composition of each pair was varied over a series of relative percentages in the experimental evaluation and the mixture parameters for each pair were regressed to the experimentally obtained data. Known vapor/liquid equilibrium behavior data available in the National Institute of Science and Technology (NIST) Reference Fluid Thermodynamic and Transport Properties Database software (Refprop 9.1 NIST Standard Database 23 from April 2016) was used for the Examples. The parameters selected for conducting the analysis were: same compressor displacement for all refrigerants, same operating conditions for all refrigerants, same compressor isentropic and volumetric efficiency for all refrigerants. In each Example, simulations were conducted using the measured vapor liquid equilibrium data. The simulation results are reported for each Example.

### Example 1: Performance in Cascade Refrigeration System

Cascade systems are generally used in applications where there is a large temperature difference (e.g., about 50-80° C., such as about 60-70° C.) between the ambient temperature and the box temperature (e.g., the difference in temperature between the air-side of the condenser in the high stage, and the air-side of the evaporator in the low stage). For example, a cascade system may be used for freezing products in a supermarket. In the following Examples the baseline cascade system uses CO2 in the low stage and R134a in the high stage, and the refrigerant combinations of the present invention involve the low stage of the cascade refrigeration system being R454A and the refrigerant used in the high-stage of the system being 1234ze (E), or R471A, or R476A or 482A.

Operating conditions are:
Condensing temperature=45° C.
High-stage Condensing Temperature-Ambient Temperature=10° C.
High-stage condenser sub-cooling=0.0° C. (system with receiver)
Evaporating temperature=−30° C., Corresponding box temperature=−18° C.
Low-stage Evaporator Superheat=3.3° C.
High-stage and Low-stage Compressor Isentropic Efficiency=65%
Volumetric Efficiency=100%.
Temperature Rise in Suction Line Low Stage=15° C.
Temperature Rise in Suction Line High Stage=10° C.
Intermediate Heat Exchanger CO₂ Condensing Temperature=0C, 5° C. and 10° C.
Intermediate Heat Exchanger Superheat=3.3° C.
Difference in Temperature in Intermediate Heat Exchanger=8° C.
   The results are reported in Table E1 below.

TABLE E1
Performance in Cascade Refrigeration System

| | Refrigerant | | Efficiency @ | Efficiency @ | Efficiency @ |
|---|---|---|---|---|---|
| Example | Low Stage | high Stage | Tcond = 0° C. | Tcond = 5° C. | Tcond = 10° C. |
| Comparative | CO2 | R134a | 100% | 100% | 100% |
| Ex. 1A | R454A | R1234ze(E) | = or >~100% | = or >~100% | = or >~100% |
| Ex. 1B | R454A | R476A | = or >~100% | = or >~100% | = or >~100% |
| Ex. 1C | R454A | R471A | = or >~100% | = or >~100% | = or >~100% |
| Ex. 1D | R454A | R482A | = or >~100% | = or >~100% | = or >~100% |

As can be seen by the results reported in Table E1 above, in every case the combination of refrigerants of the present invention, including as defined in Systems 1-7, produces an efficiency that is as high as or higher than the base-line efficiency.

### Example 2: Micro-Cascade Refrigeration System

A micro-cascade system combines a traditional medium temperature DX refrigeration system, with or without suction line liquid line heat exchanger (SLHX), which operates with the same refrigerant pairs as identified in Table 1 above. As used herein, the term “medium temperature DX refrigeration system” refers to a medium temperature system in which the evaporator is a dry evaporator.

A useful micro-cascade system is disclosed in our pending U.S. Ser. No. 16/014,863 filed Jun. 21, 2018, and U.S. Ser. No. 16/015,145 filed Jun. 21, 2018, claiming priority to U.S. Ser. 62/522,386 filed Jun. 21, 2017, U.S. Ser. 62/522,846 filed Jun. 21, 2017, 62/522,851 filed Jun. 21, 2017, and Ser. 62/522,860 filed Jun. 21, 2017, all incorporated herein by reference in their entireties.

### Operating Conditions:

### Baseline R404A Combined MT and LT System

Refrigeration Capacity
   Low Temperature: 33,000W
   Medium Temperature: 67,000W
Volumetric efficiency: 95% for both MT ad LT.
Compressor Isentropic efficiency
   Medium Temperature=70% and Low Temperature=67%.
Condensing temperature: 105° F.
Medium Temperature evaporation temperature: 20° F.
Low Temperature evaporation temperature: −20° F.
Evaporator superheat: 10° F. (both Medium and Low Temperature)
Suction line temperature rise (due to heat transfer to surroundings)
   Baseline: Medium Temperature: 25° F.; Low Temperature: 50° F.
   Cascade/self-contained without SLHX: Medium Temperature: 10° F.; Low Temperature: 25° F.
   Cascade/self-contained with SLHX: Medium Temperature: 10° F.; Low Temperature: 15° F.
SLHX efficiency when used: 65%
   The results are reported in Table E2 below.

TABLE E2
Micro-Cascade Performance Compared to R404A

| | |
|---|---|
| Refrigerant | Efficiency |

| Example | Low Stage | High Stage | relative to R404A |
|---|---|---|---|
| Comparative | R404A | R404A | 100% |
| Ex. 1A | R454A | R1234ze(E) | = or >~110% |
| Ex. 1B | R454A | R471A | = or >~110% |
| Ex. 1C | R454A | R476A | = or >~110% |
| Ex. 1D | R454A | R482A | = or >~110% |

As can be seen by the results reported in Table E2 above, in every case the combination of refrigerants of the present invention, including as defined in Systems 1-7, produced an efficiency that is about 110% or higher than the base-line case while achieving a capacity that is similar to the baseline. This is an important and unexpected advantage.

### Comparative Example 1—Centralized Distributed Direct Expansion Super Market Refrigeration System

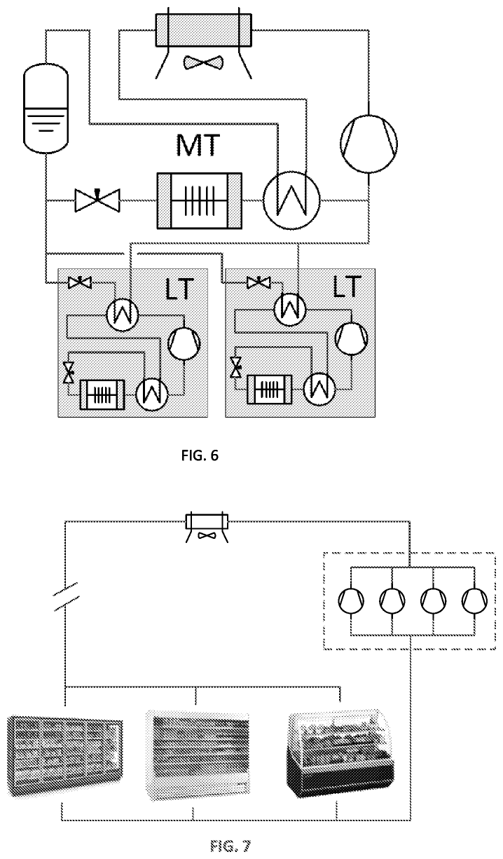

A centralized distributed supermarket refrigeration system according to process flow as illustrated in FIG. 7 is provided. The system is operated with R404A and R448A as the refrigerant at a series of ambient conditions ranging from about-13° C. to about 45° C. under the following conditions.

| | | Example Designation | |
|---|---|---|---|
| | | C1A (I) | C1B (II) |
| | | Refrigerant | |
| Description | Unit | R404A | R448a |
| Global Warming Potential (AR5) | [—] | 3943 | 1273 |
| Refrigerant Charge | [kg] | 1450 | 750 |
| Leak Rate | [%] | 15% | 10% |
| MT Evaporation Temperature | [° C.] | −6.7 | −6.7 |
| LT Evaporation Temperature | [° C.] | −28.9 | −28.9 |
| LT/MT Cooling Load | [kW] | 87/138 | 87/138 |
| Evaporator Superheat MT/LT | [° C.] | 5.5 | 5.5 |
| Suction Superheat LT | [° C.] | 27.7 | 22.2 |
| Suction Superheat MT | [° C.] | 13.8 | 8.3 |
| Isentropic Efficiency LT | [—] | 0.67 | 0.67 |
| Isentropic Efficiency MT | [—] | 0.7 | 0.7 |
| Approach Temp. Cascade HX | [K] | — | — |
| Approach Temp. Condenser | [K] | 5.5 | 5.5 |
| Minimum Condensing Temp. | [° C.] | 21 | 21 |

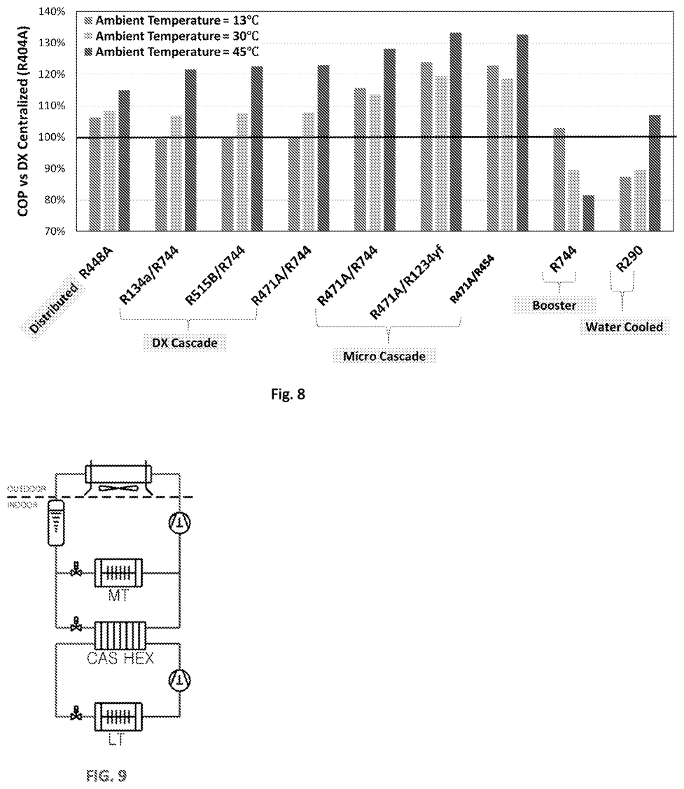

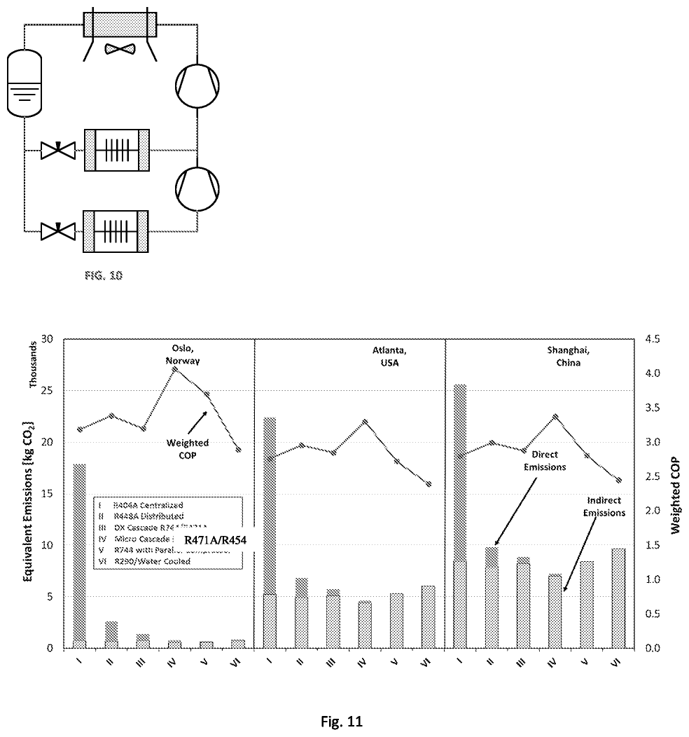

The results of the system operation (using R404A in the centralized system of Comparative Example 1 as a baseline for the COP values) are shown in FIG. 8 together with results from Example 5 below. The results of Example C2C, and using the designation I and II, in terms of Equivalent Emissions and Weighted COP are shown in FIG. 11 together with the results from Example 5C below. The results in FIG. 11 are reported for ambient temperatures reflecting approximate temperatures in operation in Oslo, Norway, Atlanta, USA and Shanghai, China).

### Comparative Example 2—Direct Expansion Cascade Super Market Refrigeration System

A direct expansion cascade supermarket refrigeration system according to process flow as illustrated in FIG. 9 is provided. The system is operated, at a series of ambient conditions ranging from about −13° C. to about 45° C., with three different refrigerants (R134a, R515B and R471A) in the high side (MT system) and R744 in the low side (LT system) under the following conditions.

| | | Example Designation | | |
|---|---|---|---|---|
| | | C2A | C2B | C2C (III) |
| | | Refrigerant | | |
| Description | Unit | R134a/R744 | R515B/R744 | R471A/R744 |
| Global Warming Potential (AR5) | [—] | <150 | <300 | <150 |
| Refrigerant Charge | [kg] | 1450 | 1450 | 1450 |
| Leak Rate | [%] | 15% | 15% | 15% |
| MT Evaporation Temperature | [° C.] | −6.7 | −6.7 | −6.7 |
| LT Evaporation Temperature | [° C.] | −28.9 | −28.9 | −28.9 |
| LT/MT Cooling Load | [kW] | 87/138 | 87/138 | 87/138 |
| Evaporator Superheat MT/LT | [° C.] | 5.5 | 5.5 | 5.5 |
| Suction Superheat LT | [° C.] | 27.7 | 27.7 | 27.7 |
| Suction Superheat MT | [° C.] | 13.8 | 13.8 | 13.8 |
| Isentropic Efficiency LT | [—] | 0.6 | 0.6 | 0.6 |
| Isentropic Efficiency MT | [—] | 0.7 | 0.7 | 0.7 |
| Approach Temp. Cascade HX | [K] | 5.5 | 5.5 | 5.5 |
| Approach Temp. Condenser | [K] | 5.5 | 5.5 | 5.5 |
| Minimum Condensing Temp. | [° C.] | 21 | 21 | 21 |

The results of the system operation (using R404A in the centralized system of Comparative Example 1 as a baseline for the COP) are shown in FIG. 8 together with the results from Example 5 below. The results of Example C2C, and using the designation III, in terms of Equivalent Emissions and Weighted COP are shown in FIG. 11, together with the results from Example 5C below. The results in FIG. 11 are reported for ambient temperatures reflecting approximate temperatures in operation in Oslo, Norway, Atlanta, USA and Shanghai, China).

### Comparative Example 3—CO2 Booster Super Market Refrigeration System

A CO2 booster system using a parallel compression system and mechanical subcooler in a supermarket refrigeration system according to process flow as illustrated in FIG. 10 is provided. The system is operated, at a series of ambient conditions ranging from about −13° C. to about 45° C., with R744 and CO2 booster under the following conditions.

| | | Example Designation |
|---|---|---|
| | | C3 (V) |
| | | Refrigerant |
| Description | Unit | R744/CO2 |
| Global Warming Potential (AR5) | [—] | 1 |
| Refrigerant Charge | [kg] | 1000 |
| Leak Rate | [%] | 15% |
| MT Evaporation Temperature | [° C.] | −6.1 |
| LT Evaporation Temperature | [° C.] | −28.3 |
| LT/MT Cooling Load | [kW] | 87/138 |
| Evaporator Superheat MT/LT | [° C.] | 5.5 |
| Suction Superheat LT | [° C.] | 22.2 |
| Suction Superheat MT | [° C.] | 8.3 |
| Isentropic Efficiency LT | [—] | 0.67 |
| Isentropic Efficiency MT | [—] | 0.7 |
| Approach Temp. Cascade HX | [K] | |
| Approach Temp. Condenser | [K] | 5.5 SC, 2.5 TC |
| Minimum Condensing Temp. | [° C.] | 10 |

The results of the system operation (using R404A in the centralized system of Comparative Example 1 as a baseline for the COP values) are shown in FIG. 8, together with the results from Example 5 below. The results of Example C3, and using the designation V, in terms of Equivalent Emissions and Weighted COP, are shown in FIG. 11 together with the results from Example 5C below. The results are reported in FIG. 8 for ambient temperatures reflecting approximate temperatures in operation in Oslo, Norway, Atlanta, USA and Shanghai, China.

### Comparative Example 4—R290 Water-Cooled Super Market Refrigeration System

An R290 water cooled supermarket refrigeration system is provided and is operated at a series of ambient conditions ranging from about −13° C. to about 45° C., with R744 and CO2 booster under the following conditions.

| | | Example Designation |
|---|---|---|
| | | C4 (VI) |
| | | Refrigerant |
| Description | Unit | R290 |
| Global Warming Potential (AR5) | [—] | 3 |
| Refrigerant Charge | [kg] | 750 |
| Leak Rate | [%] | 10% |
| MT Evaporation Temperature | [° C.] | −5.5 |
| LT Evaporation Temperature | [° C.] | −27.8 |
| LT/MT Cooling Load | [kW] | 87/138 |
| Evaporator Superheat MT/LT | [° C.] | 5.5 |
| Suction Superheat LT | [° C.] | 5.5 |
| Suction Superheat MT | [° C.] | 5.5 |
| Isentropic Efficiency LT | [—] | 0.52 |
| Isentropic Efficiency MT | [—] | 0.55 |
| Approach Temp. Cascade HX | [K] | 5.5 |
| Approach Temp. Condenser | [K] | 5.5 |
| Minimum Condensing Temp. | [° C.] | 15.5 |

The results of the system operation (using R404A in the centralized system of Comparative Example 1 as a baseline for the COP) are shown in FIG. 8 together with the results from Example 5 below. The results of Example C4, and using the designation VI, in terms of Equivalent Emissions and Weighted COP are shown in FIG. 11, together with the results from Example 5C below. The results are reported for ambient temperatures reflecting approximate temperatures in operation in Oslo, Norway, Atlanta, USA and Shanghai, China.

### Example 5—Micro Cascade Super Market Refrigeration System

A micro cascade supermarket refrigeration system according to process flow as illustrated in FIG. 6 is operated, at a series of ambient conditions ranging from about −13C to about 45C, with R471A in the high side (MT system) and with R454A) in the low side (LT system) under the following conditions.

| | | Example Designation | | |
|---|---|---|---|---|
| | | 5A | 5B | 5C (IV) |
| | | Refrigerant(high/low) | | |
| Description | Unit | R471A/R744 | R471A/R1234yf | R471A/R454A |
| Global Warming Potential (AR5) | [—] | <150 | <300 | <150 |
| Refrigerant Charge | [kg] | 750 | 750 | 750 |
| Leak Rate | [%] | 10% | 10% | 10% |
| MT Evaporation Temperature | [° C.] | −6.7 | −6.7 | −6.7 |
| LT Evaporation Temperature | [° C.] | −27.8 | −27.8 | −27.8 |
| LT/MT Cooling Load | [kW] | 87/138 | 87/138 | 87/138 |
| Evaporator Superheat MT/LT | [° C.] | 5.5 | 5.5 | 5.5 |
| Suction Superheat LT | [° C.] | 5.5 | 5.5 | 5.5 |
| Suction Superheat MT | [° C.] | 13.8 | 13.8 | 13.8 |
| Isentropic Efficiency LT | [—] | 0.6 | 0.6 | 0.6 |
| Isentropic Efficiency MT | [—] | 0.7 | 0.7 | 0.7 |
| Approach Temp. Cascade HX | [K] | 5.5 | 5.5 | 5.5 |
| Approach Temp. Condenser | [K] | 5.5 | 5.5 | 5.5 |
| Minimum Condensing Temp. | [° C.] | 15.5 | 15.5 | 15.5 |

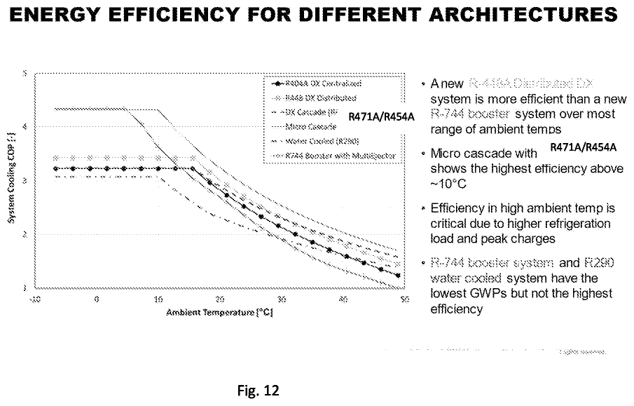

The results of the system operation (using R404A in the centralized system of Comparative Example 1 as a baseline for the COP values) are shown in FIG. 8, together with the results from the Comparative Examples above, for three sets of ambient conditions, namely 13° C., 30° C. and 45° C., with the first bar in each group representing 13° C. ambient, the second bar in each group representing 30° C. ambient and the third bar in each group representing 45° C. ambient. These results show that for each of these ambient temperature conditions the micro-cascade system of the present invention produces the highest COP of all tested systems. Similarly, FIG. 12 illustrates that, as a function ambient temperature, the micro-cascade system of the present invention designated as Example 5C produced results that were dramatically superior to all tested systems (except the R744 booster system) at ambient temperatures below about 5° C., and was significantly superior to all systems, including the R744 booster system, at temperatures above 5° C. These results are highly beneficial and unexpected.

The results of this Example in terms of Life Cycle Performance Analysis (Equivalent Emissions and Weighted COP) are shown in FIG. 11 together with the results from the designated Comparative Examples above. The emissions values are calculated as follows:

Direct Emissions=Refrigerant Charge (kg)×((Annual Leak×Lifetime)+End of Life Losses)×GWP

Indirect Emissions=Annual Energy Consumption×Lifetime×Emission Factor

As can be seen from FIG. 11, the micro-cascade system of the present invention designated as Example 5C (IV in FIG. 11) produces the highest weighted COP of all tested systems in each of the illustrated ambient temperature conditions. Furthermore, the micro-cascade system of the present invention designated as Example 5C (IV in FIG. 11) produces both direct and indirect emissions that are dramatically superior to the R404A centralized system, the R448A distributed system and the R477/R471A DX cascade system in even the lowest ambient conditions shown in FIG. 9, and it has the lowest emissions of all systems at the ambient conditions represented by both Atlanta USA and Shanghai China. These results are highly beneficial and unexpected. These results also show that systems with refrigerants having the lowest GWP does not necessarily lead to the lowest emissions. Rather, overall emissions of the refrigeration systems depend on the energy efficiency of a refrigerant or combination of refrigerants in the system as well as on the GWP of the refrigerant or refrigerants in the system.

What is claimed is:

1. A cascade refrigeration system, comprising:
a. a low stage refrigeration circuit comprising:
a low stage refrigerant consisting essentially of R454A; and
a compressor;
b. an inter-circuit heat exchanger in which said low stage refrigerant condenses; and
c. a high stage refrigeration circuit comprising a high stage refrigerant which: (i) has either Class A1 or Class A2L flammability; (ii) evaporates at a temperature below said low stage refrigerant condensing temperature; and (iii) comprises at least about 77% by weight of HFO-1234ze (E), wherein said high stage refrigerant evaporates in said inter-circuit heat exchanger by absorbing heat from said refrigerant in said low stage refrigeration circuit.

2. The cascade refrigeration system of claim 1 wherein said high stage refrigerant has a Class A1 flammability.

3. The cascade refrigeration system of claim 1 wherein said high stage refrigerant comprises at least about 75% of HFO-1234ze (E).

4. The cascade refrigeration system of claim 3 wherein said high stage refrigerant consists essentially of HFO-1234ze (E).

5. The cascade refrigeration system of claim 3 wherein said high stage refrigerant consists essentially of R471A.

6. The cascade refrigeration system of claim 3 wherein said high stage refrigerant consists essentially of R476A.

7. The cascade refrigeration system of claim 1 wherein said low stage refrigeration circuit comprises a plurality of low temperature refrigeration circuits.

8. The cascade refrigeration system of claim 1 wherein said low stage refrigeration circuit compressor comprises at least one compressor having a horsepower rating of about 2 horsepower or less.
